(19) United States
(12) Patent Application Publication
(10) Pub. No.: US 2026/0030169 A1
(43) Pub. Date: Jan. 29, 2026

(54) Write Amplification Reduction with Sub-Indirection Unit (IU) Hinting

(71) Applicant: Sandisk Technologies, Inc., Milpitas, CA (US)

(72) Inventors: Karin INBAR, Ramat Hasharon (IL); Neil HUTCHISON, Hudsonville, MI (US); Steven T. SPROUSE, San Jose, CA (US); Judah Gamliel HAHN, Ofra (IL)

(73) Assignee: Sandisk Technologies, Inc., Milpitas, CA (US)

(21) Appl. No.: 19/266,356

(22) Filed: Jul. 11, 2025

Related U.S. Application Data
(60) Provisional application No. 63/675,367, filed on Jul. 25, 2024.

(51) Int. Cl. G06F 12/0884; G06F 12/123; G06F 13/16

(52) U.S. Cl. CPC G06F 12/0884; G06F 12/123; G06F 13/1673

(57) ABSTRACT

Sub indirection unit (IU) write ordering can be achieved by aggregating log data in local cache. The cache is IU sized. If a write command is analyzed and determined to need to be aggregated, through a host provided hint or perhaps a determination of sequential write commands, the log data is placed in the local cache to aggregate log data. The log data is aggregated in order both sequentially and atomically. The log data is written to a cache and then, when additional log data is to be aggregated with the log data, copied to a new cache along with the additional log data so that the order can be maintained. Sufficient log data is aggregated until IU size is reached at which time the entire log data of a full IU sized cache is sent to the memory device.

### CROSS-REFERENCE TO RELATED APPLICATIONS

This application claims benefit of U.S. Provisional Patent Application Ser. No. 63/675,367, filed Jul. 25, 2024, which is herein incorporated by reference.

### BACKGROUND OF THE DISCLOSURE

### Field of the Disclosure

Embodiments of the present disclosure generally relate to maintaining indirection unit (IU) sized log writes.

### Description of the Related Art

File systems and application stacks generate log data for auditing, debugging, check pointing, and general operation tracking. Logs are typically characterized by very short updates, which need to be appended to an existing file extent or log. These updates may be as short as a line of text or a fixed-length data structure. The updates can be a circular buffer within a fixed logical block address (LBA) range or a file that is dynamically extended incrementally.

The write pattern for a log is typically atomic and strictly ordered. Synchronous write commands ensure that one write command is not ordered before another one. The logging application expects the updates to be atomically committed in the order sent.

Storage protocols currently support atomic write commands using techniques such as FUA (Force Unit Access) flag and the Flush command to ensure that write commands are safely committed to nonvolatile memory (NVM), but the features do not guarantee ordering, even for write commands that were already completed back to the host device. The FUA flag is defined in the NVM express (NVMe) specification, and can be specified by applications when creating a file using the FILE_FLAG_WRITE_THROUGH flag or the O_SYNC flag depending on the operating system.

These flags were originally designed for hard drives with volatile caches, and ensure that the volatile cache is flushed prior to the application-level write command being completed. While client solid state drives (SSDs) with volatile write caches continue to honor these flags, enterprise SSDs with power-fail protection do not. Enterprise SSDs guarantee that write data is protected from power loss upon completion of the command, and will do so regardless of any host-side flags. However, as a side effect, the atomicity and ordering of small writes to NAND is not guaranteed. Thus, overlapping write commands may not be sequenced correctly if the command length is shorter than the atomic write unit of the SSD.

Atomic write unit in high-capacity SSDs can be much larger than a single LBA. In an example 64 TB SSD, the Indirection Unit (IU) is 16 KB, meaning that writes of less than 16 KB are not atomic. While this is reported to the host device, it is not always practical to coalesce or aggregate log writes into IU-sized units, which can vary based on underlying media and are typically greater than the required update size.

Therefore, there is a need in the art for improved sub-IU log write management.

### SUMMARY OF THE DISCLOSURE

Sub indirection unit (IU) write ordering can be achieved by aggregating log data in local cache. The cache is IU sized. If a write command is analyzed and determined to need to be aggregated, through a host provided hint or perhaps a determination of sequential write commands, the log data is placed in the local cache to aggregate log data. The log data is aggregated in order both sequentially and atomically. The log data is written to a cache and then, when additional log data is to be aggregated with the log data, copied to a new cache along with the additional log data so that the order can be maintained. Sufficient log data is aggregated until IU size is reached at which time the entire log data of a full IU sized cache is sent to the memory device.

In one embodiment, a data storage device comprises: a memory device; and a controller coupled to the memory device, wherein the controller is configured to: first determine whether processing a write command would result in log data filling less than a predetermined indirection unit (IU) size; second determine whether the log data should be aggregated; and route the log data to an aggregation cache.

In another embodiment, a data storage device comprises: a memory device; and a controller coupled to the memory device, wherein the controller is configured to: receive a first write command to write first log data filling less than a predetermined indirection unit (IU) size; write the first log data to a portion of a first cache buffer having the predetermined IU size; receive a second write command to write second log data filling less than the predetermined IU size; write the second log data to a second cache buffer having the predetermined IU size; and route the second cache buffer to the memory device.

In another embodiment, a data storage device comprises: means to store data; and a controller coupled to the means to store data, wherein the controller is configured to: receive an indirection unit (IU) sized cache from a host device, wherein the cache includes log data from a plurality of write commands.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of a nonvolatile memory express (NVMe) write command bit descriptions according to one embodiment.

FIG. 3 is a schematic illustration of a write sequence according to one embodiment.

FIG. 4 is a flowchart illustrating write command processing according to one embodiment.

FIG. 5 is a flowchart illustrating write command processing according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Sub indirection unit (IU) write ordering can be achieved by aggregating log data in local cache. The cache is IU sized. If a write command is analyzed and determined to need to be aggregated, through a host provided hint or perhaps a determination of sequential write commands, the log data is placed in the local cache to aggregate log data. The log data is aggregated in order both sequentially and atomically. The log data is written to a cache and then, when additional log data is to be aggregated with the log data, copied to a new cache along with the additional log data so that the order can be maintained. Sufficient log data is aggregated until IU size is reached at which time the entire log data of a full IU sized cache is sent to the memory device.

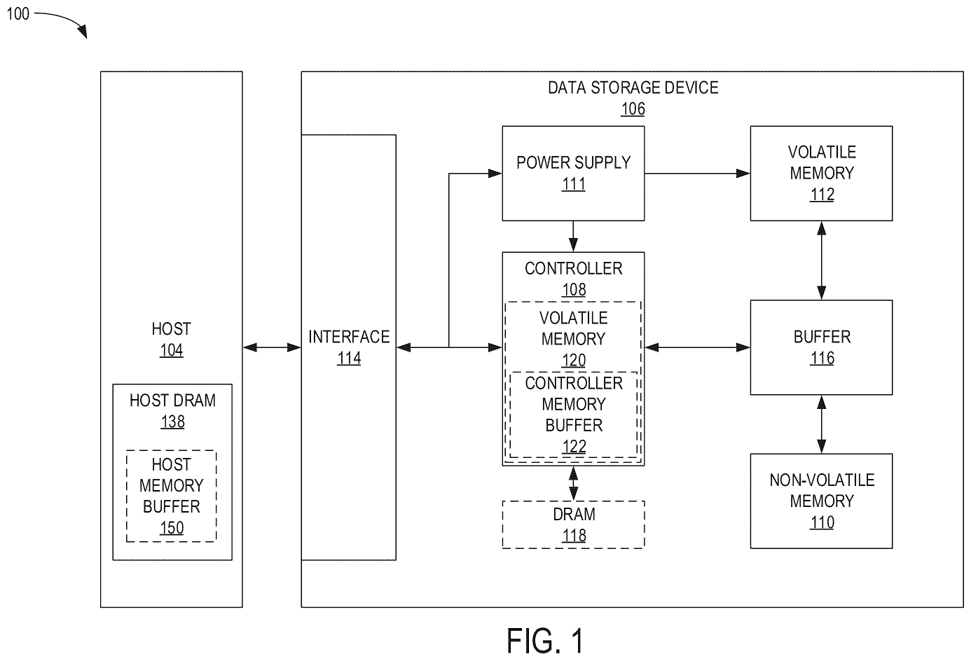

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

Generally speaking, there are logs that are atomic and strictly ordered, and as noted above, circular buffers have caused issues. The logs need to be ordered correctly such that one write command completes before the next write command is written. Ultimately, the data will get written, and atomicity makes sure that the writes are the correct size. The internal read-modify-write will make sure the writes do not overlap and are consistent.

The NVMe atomic write unit is declared by a data storage device to indicate what unit of storage will be used. If the writes are smaller than the atomic write unit, the internal read-modify-write operation of the SSD will ensure that there is no partial application from different writes to the same LBA range. However, atomicity does not guarantee ordering.

TABLE

| | LBA 0 | LBA 1 | LBA 2 | LBA 3 | LBA 4 |
|---|---|---|---|---|---|
| Result 1 | A | A | A | A | B |
| Result 2 | A | B | B | B | B |
| Result 3 | A | A | B | B | B |
| Result 4 | A | B | A | A | B |

The table above shows an example of two commands when the atomic write unit is 4 where command A is for LBAs 0-3 and command B is from LBAs 1-4. There are two valid results (i.e., Results 1 and 2), and two invalid results (i.e., Results 3 and 4). The reason is that no partial overlap of writes is allowed. Results 3 and 4 are partial overlaps where LBAs 1-3 are mixed and thus not completely command A or command B. LBAs 0 and 4 do not overlap. Result 1 is valid because all of command A is present (LBAs 0-3) and part of command B is present (LBA 4). Result 2 is valid because all of command B is present (LBAs 1-4) and part of command A is present (LBA 0). While Results 1 and 2 are both valid, it would be valuable to know which result is actually obtained. Results 3 and 4 do not have either command A or command B completely present. Just partials of both commands are present, which is a partial overlap of writes, which is not permitted. Atomicity doesn't guarantee ordering. Atomicity only guarantees that the logs won't step on each other and that the updates won't step on each other.

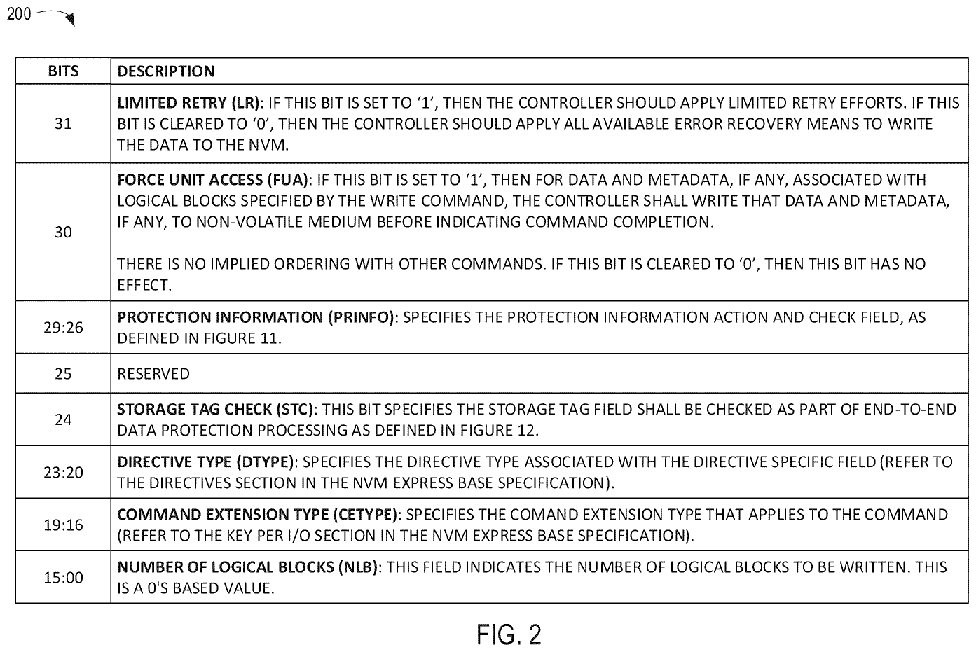

FIG. 2 is a schematic illustration 200 of NVMe write command bit descriptions according to one embodiment. FIG. 2 exemplifies the force unit access (FUA) for bit 30. If the FUA bit is set to 1, then for data and metadata, if any, associated with logical blocks specified by the write command, the controller will write that data and metadata, if any, to NVM before indicating command completion. There is no implied ordering with the FUA bit.

There is another flag called namespace preferred write granularity (NPWG) that indicates what the ideal write granularity to avoid overlap is. Some SSDs have different queues for different kinds of commands based on whether or not the commands comply with the write impact. Typically, commands that do not conform to the preferred write alignment and granularity will be treated differently from commands that do. NVMe does not guarantee ordering between commands, so commands can be executed internally in a different order.

For example, if there is a conformal write command, the conformal write command will go to one queue (e.g., a fast queue). If there is a non conformal write command, such as a command that overlaps, isn't aligned, or doesn't meet the write granularity that is desired, then the non conformal write command goes to a different queue (e.g., slow queue) because the data storage device has to do an internal read-modify-write. The problem is, commands that go into the fast queue can pass commands that are going through the slow queue. Ultimately, the commands will all get to the appropriate location because of power protection and atomicity and other data protection features, but the commands don't necessarily get there in the correct order because commands can pass each other.

As noted, previous solutions to atomicity and ordering involve using OS flags and corresponding NVMe features to indicate a need for synchronicity. However, the features do not work in modern enterprise SSDs.

Another approach is to wait for each write command to complete before the next write command is submitted. Once a write command is completed by the SSD, ordering is guaranteed vis-à-vis writes that were not yet submitted the time of completion. However, waiting for completion can impact performance by forcing synchronicity at the application level.

Another potential approach is for the host device to pad each write command to a full IU, but such is prohibitive in terms of write amplification.

As discussed herein, there are two methods proposed for sub-IU write ordering: host side aggregation and device side aggregation. Host side command aggregation enables power-safe sub-IU aggregation without forcing a read-modify-write operation on the data storage device. Host side command aggregation can be applied to existing enterprise NVMe devices but requires a host-side cache of previous writes to the same IU. The cache can be resident in the driver, file system, or application layers.

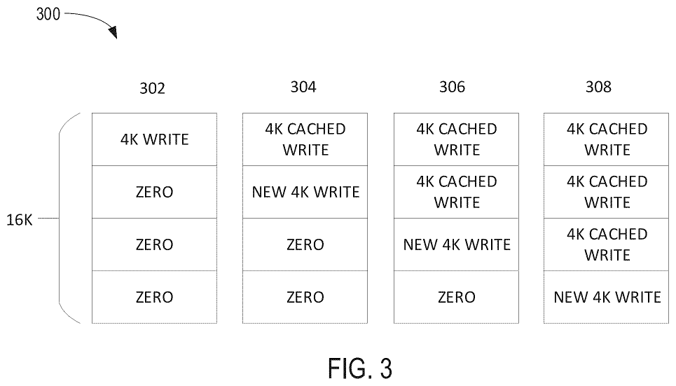

As discussed herein, the host device implements a write pattern that keeps a small cache of previous writes to the same IU. Each write would be to a full IU, but would incrementally add data, overwriting the previous write. FIG. 3 is a schematic illustration 300 of a write sequence according to one embodiment. FIG. 3 illustrates the order of write commands to the same LBA range assuming a 16K IU. The write pattern can also be used with sub-LBA writes. A compatible device would recognize the pattern as naturally aligned and write optimally.

For FIG. 3, it is assumed that there is a sequential update with 4K records in a 16K IU. It is to be understood that 4K and 16K are merely examples and not to be limiting. Other sizes are contemplated. The write sequence is shown in FIG. 3. The first write is to a new IU 302. Each additional write then requires a read of the previous content and then an application of the new content. The sequential update is done currently within the SSD as a read-modify-write operation.

Depending upon the way buffers work and depending upon the ordering and when the commands are pulled from the queues, the commands may come in different orders. Thus, there may be a situation where the third command write arrives before the second command write because there's no ordering between commands. The third command write would actually see a zero in the second slot and then the third command write will overlap the second slot. Later, the second command will arrive. It is valid, unless there's some kind of an interruption in one of the commands such that one of the commands doesn't arrive for some reason. For a client device writing, the writes can be guaranteed to be done in order because you can guarantee that the writes are done in order, but enterprise devices do not have a volatile write caches and thus cannot guarantee the writes are done in order.

Because the log content is known at the file system level, it is more efficient to send full 16 KB writes in each command by caching previous writes for the same IU. Each write would be a full IU in length, and thus would be written without read-modify-write. Power fail protection is preserved since each write command is committed. Ordering and atomicity would be preserved at an IU level.

Basically, host side coalescing involves each write right being a full IU, 16K in this example. The first write would be to a 16K buffer with 4K in the beginning and the rest zeros. The second write would be the same 4K that was in the first write plus the next 4K, and the rest zeros. The third write would be the same two 4K writes from the second write along with the new 4K write and the rest zeros. The fourth write would be the same three 4K writes from the third write along with the new 4K write to complete the IU and thus ordering atomicity is preserved. What is needed on the host side is a little tiny buffer for each IU write (e.g., 4 for the example above). It is to be understood that there may be thousands of writes occurring running at once, but each needs a little buffer for the size of the IU. The NPWG write holds the previous writes even though the writes are sent every single time and in order.

Expanding on the example, the write for the first command is written to new IU 302. Because the write for the first command is a 4K write, the command just goes to the first open slot in IU 302 which is a 16K IU. The remaining slots would be zeros. The second command write, the third command write, and the fourth command write all need to be written as well. To do the writing, the data storage device needs to do a read-modify-write each time. Assuming the commands come in order, the second command write would involve reading the first command write; writing the first command write as a cached write in the first slot of new IU 304; writing the second command write as a new 4K write in the second slot; and writing zeros in the third and fourth slots. The third command write would involve reading the first and second command writes; writing the first and second command writes as cached writes in the first and second slots of new IU 306; writing the third command write as a new 4K write in the third slot; and writing zeros in the fourth slot. The fourth command write would involve reading the first, second, and third command writes; writing the first, second, and third command writes as cached writes in the first, second, and third slots of new IU 308; writing the fourth command write as a new 4K write in the fourth slot.

The alternative is device assisted coalescing. A data storage device can perform the same pattern as proposed for the host above in regards to FIG. 3, using a local write cache that is dynamically allocated when the pattern is determined. This can be using a hint such as the FUA flag or a context attribute such as sequential request. Since storage resources are limited, additional signaling may be needed to ensure that local coalescing memory resources are not exceeded. If coalescing resources on the SSD are exceeded, the current read-modify-write pattern would be used.

In device side coalescing, the same buffers are used, but instead of sitting on the host device, the buffers are in the data storage device. Device side coalescing involves using the FUA flag, context attribute, or some other hint to determine that the commands should be placed into the special cached. Then, when the data storage device determines that a write command isn't a full IU and needs coalescing, the data storage device will look for the previous write before performing the next write. Thus, if the data storage device misses the write, the data storage device will know that the write was missed because of the flag (or attribute or other hint) indicating that the write was to be sequential.

To be a little more specific on device side coalescing, device side dynamic aggregation cache for sub-IU writes will guarantee ordering. The cache will be power-fail protected and can reside in either volatile memory (SRAM/DRAM) or non-volatile memory (SCM, SLC, or any other form of NVM). Device side coalescing does not require host-side changes but will only operate with devices that perform the optimization.

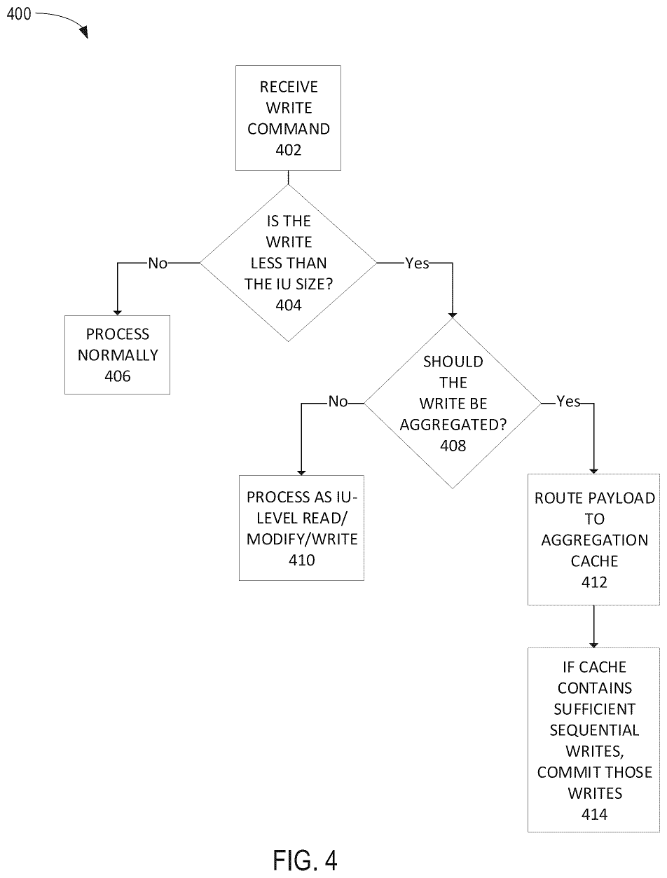

In device side dynamic aggregation, cache size is determined by the workload, and may be dynamically created or provisioned when a logging workload is detected. The upper limit of cache size is based on the number of potential simultaneous logs that are created. FIG. 4 is a flowchart 400 illustrating write command processing according to one embodiment. The process begins when a write command is received at block 402. A determination is then made at block 404 regarding whether the write command is for less than the IU size. If the write is not less than the IU size, then the write command is processed normally at block 406. However, if the write is for less than the IU, then a determination is made at block 408 regarding whether the write should be aggregated. If the write should not be aggregated, then the write command is processed as an IU-level read-modify-write operation at block 410. However, if the write should be aggregated, then the write command is processed by routing the payload to the aggregation cache at block 412 followed by writing an entire IU from cache if the cache contains sufficient sequential writes at block 414.

The decision of whether to aggregate the write payload may be based on one or more of the following factors: a hint from the host (e.g. the write command includes a sequential request flag); previous write commands to neighboring LBAs are sequential to this command and also have payload sizes that are less than an IU; previous write commands to neighboring LBAs are inferred to be sequential using locality analysis, and are less than an IU in length; and previous write commands to the same LBA indicating that the host is using a read-modify-write pattern to commit this log.

As noted above, multiple aggregations may happen in parallel, since hosts typically have many processes running, each with their own logs. If there is contention over the available number of cache locations, the cache may be dynamically grown based on available space, or some sub-IU writes may be evicted to make room for others. Eviction may happen using any known cache management algorithm such as simple Least-Recently-Used (LRU) or a more complex algorithm combining LRU and other metrics.

The cache may be committed when a single IU is aggregated, or multiple IUs may be collected to improve write placement. It should be noted that logs are very rarely read, so read performance is not generally a consideration for log placement. As such, cache contents may be routed to the lowest tier of NAND in a multi-tiered product (i.e. one with SLC and QLC.)

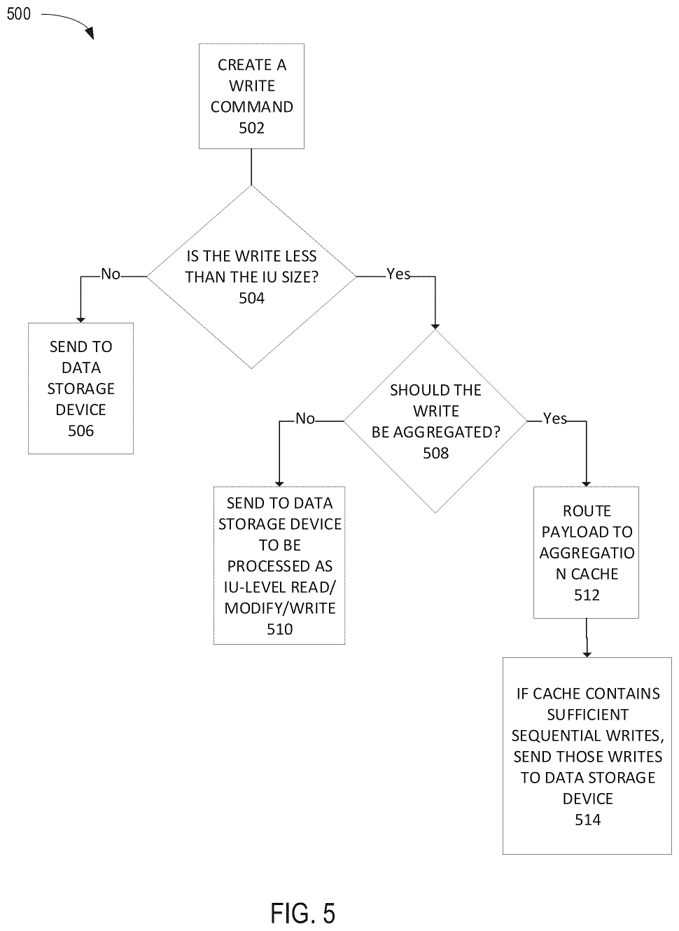

FIG. 5 is a flowchart 500 illustrating write command processing according to one embodiment. The process begins when a write command is generated at block 502. A determination is then made at block 504 regarding whether the write command is for less than the IU size. If the write is not less than the IU size, then the write command is processed normally by sending the write command to the data storage device at block 506. However, if the write is for less than the IU, then a determination is made at block 508 regarding whether the write should be aggregated. If the write should not be aggregated, then the write command is sent to the data storage device to be processed as an IU-level read-modify-write operation at block 510. However, if the write should be aggregated, then the write command is processed by routing the payload to the aggregation cache at block 512 followed by sending the entirety of an IU cache to the data storage device if the cache contains sufficient sequential writes at block 514.

By using full IUs for writing, write amplification is reduced in an enterprise logging workload, including check pointing for AI workloads and auditing devices. Writing full IUs can also be used in automotive workloads where very long life is desired.

In one embodiment, a data storage device comprises: a memory device; and a controller coupled to the memory device, wherein the controller is configured to: first determine whether processing a write command would result in log data filling less than a predetermined indirection unit (IU) size; second determine whether the log data should be aggregated; and route the log data to an aggregation cache. The second determining is based upon a hint received from a host device. The second determining is based upon previously received write commands that are sequential to the write command. The previous commands are neighboring commands that have payload sizes that are less than the IU size in length. The second determining is based upon previously received write commands that are inferred to be sequential using locality analysis. The previous commands are neighboring commands that have payload sizes that are less than the IU size in length. The second determining is based upon previous received write commands that belong to a same logical block address (LBA) as the write command. The routing comprises sending the aggregation cache to the memory device. Multiple aggregations occur in parallel. The controller is configured to route sub-IU caches based upon a cache management algorithm. The cache management algorithm is a least recently used (LRU) algorithm.

In another embodiment, a data storage device comprises: a memory device; and a controller coupled to the memory device, wherein the controller is configured to: receive a first write command to write first log data filling less than a predetermined indirection unit (IU) size; write the first log data to a portion of a first cache buffer having the predetermined IU size; receive a second write command to write second log data filling less than the predetermined IU size; write the second log data to a second cache buffer having the predetermined IU size; and route the second cache buffer to the memory device. The controller is further configured to read the first log data from the first cache buffer and copy the first log data to a portion of the second cache buffer. The controller is configured to fill a remainder of the first cache buffer with zeros after writing the first log data. The routing occurs after the second cache buffer is filled with log data. The routing occurs when the second cache buffer is partially filled with log data. The first cache buffer and the second cache buffer are disposed in volatile memory.

In another embodiment, a data storage device comprises: means to store data; and a controller coupled to the means to store data, wherein the controller is configured to: receive an indirection unit (IU) sized cache from a host device, wherein the cache includes log data from a plurality of write commands. The log data is atomically and sequentially ordered. The log data collectively is IU sized.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
first determine whether processing a write command would result in log data filling less than a predetermined indirection unit (IU) size;
second determine whether the log data should be aggregated; and
route the log data to an aggregation cache.

2. The data storage device of claim 1, wherein the second determining is based upon a hint received from a host device.

3. The data storage device of claim 1, wherein the second determining is based upon previously received write commands that are sequential to the write command.

4. The data storage device of claim 3, wherein the previous commands are neighboring commands that have payload sizes that are less than the IU size in length.

5. The data storage device of claim 1, wherein the second determining is based upon previously received write commands that are inferred to be sequential using locality analysis.

6. The data storage device of claim 5, wherein the previous commands are neighboring commands that have payload sizes that are less than the IU size in length.

7. The data storage device of claim 1, wherein the second determining is based upon previous received write commands that belong to a same logical block address (LBA) as the write command.

8. The data storage device of claim 1, wherein the routing comprises sending the aggregation cache to the memory device.

9. The data storage device of claim 1, wherein multiple aggregations occur in parallel.

10. The data storage device of claim 1, wherein the controller is configured to route sub-IU caches based upon a cache management algorithm.

11. The data storage device of claim 10, wherein the cache management algorithm is a least recently used (LRU) algorithm.

12. A data storage device, comprising:
a memory device; and
a controller coupled to the memory device, wherein the controller is configured to:
receive a first write command to write first log data filling less than a predetermined indirection unit (IU) size;
write the first log data to a portion of a first cache buffer having the predetermined IU size;
receive a second write command to write second log data filling less than the predetermined IU size;
write the second log data to a second cache buffer having the predetermined IU size; and
route the second cache buffer to the memory device.

13. The data storage device of claim 12, wherein the controller is further configured to read the first log data from the first cache buffer and copy the first log data to a portion of the second cache buffer.

14. The data storage device of claim 12, wherein the controller is configured to fill a remainder of the first cache buffer with zeros after writing the first log data.

15. The data storage device of claim 12, wherein the routing occurs after the second cache buffer is filled with log data.

16. The data storage device of claim 12, wherein the routing occurs when the second cache buffer is partially filled with log data.

17. The data storage device of claim 12, wherein the first cache buffer and the second cache buffer are disposed in volatile memory.

18. A data storage device, comprising:
means to store data; and
a controller coupled to the means to store data, wherein the controller is configured to:
receive an indirection unit (IU) sized cache from a host device, wherein the cache includes log data from a plurality of write commands.

19. The data storage device of claim 18, wherein the log data is atomically and sequentially ordered.

20. The data storage device of claim 18, wherein the log data collectively is IU sized.
